(19) United States
(12) Patent Application Publication
(10) Pub. No.: US 2007/0202413 A1
(43) Pub. Date: Aug. 30, 2007

(54) PEGYLATED FULLERENES AS LITHIUM SOLID ELECTROLYTE

(75) Inventors: Fred Wudl, Santa Barbara, CA (US); Galen Stucky, Santa Barbara, CA (US); Ken Tasaki, Goleta, CA (US); Hengbin Wang, Camarillo, CA (US); Jeffrey V. Gasa, Goleta, CA (US); Ryan DeSousa, Goleta, CA (US)

Correspondence Address: JOHN P. O'BANION;O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA, Oakland, CA (US)

(21) Appl. No.: 11/677,833

(22) Filed: Feb. 22, 2007

Related U.S. Application Data
(60) Provisional application No. 60/776,403, filed on Feb. 23, 2006.

(51) Int. Cl. H01M 10/36; H01M 6/18; C01B 31/02

(52) U.S. Cl. 429/304; 429/317; 423/445 B

(57) ABSTRACT

Pegylated fullerenes, for use with a lithium ion battery as a solvent-free electrolyte, having the formula {[CH₃-(PEO)]ₘ-LINKER}ₙ-fullerene, with n≧1, m≧1 to 5, and the LINKER group comprising a moiety capable of attaching each of the CH₃-(PEO)-chains to the fullerene.

### CROSS-REFERENCE TO RELATED APPLICATIONS

This application claims priority from U.S. provisional application Ser. No. 60/776,403, filed on Feb. 23, 2006, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to pegylated fullerenes that are utilized as solvent-free or solid electrolytes in lithium ion (Li⁺) batteries. More particularly to pegylated C₆₀ containing membranes or films that are employed in lithium ion batteries as solvent-free or solid electrolytes.

2. Description of Related Art

Lithium ion batteries are used frequently due to high voltages and energy densities. Organic solvent-based electrolytes with LiPF₆ as a typical salt currently dominate the Li⁺battery electrolyte market. While these electrolytes exhibit high ionic conductivities, they impose problems associated with liquids such as leakage of solvents or catching fire, the low volumetric energy densities, and the environmental concerns. As the voltage and the energy density required for portable consumer electronics devices increase, these issues will become more serious. Solvent free electrolyte, on the other hand, can bring a number of advantages over liquid electrolytes besides the safety: no need for a separator, thus a lower cost and a higher energy density; more flexibility in compartmentalization of cells and their thickness; a possibility of using lithium metal as the anode which has a higher capacity than graphite. Liquid electrolytes do not allow the use of lithium metal due to the severe reactions between the metal and the electrolyte.

As the voltage and the energy density required for portable consumer electronics devices increase, the safety issues will become more paramount (D. H. Doughty and S. C. Levy In: The 36th Battery Symposium in Japan, Kyoto, The Committee of Battery Technology, The Electrochemical Society of Japan, Kyoto (1995), p. 1). Battery manufacturers are increasingly under pressure to improve safety. Furthermore, a market for secondary batteries in automobile applications is expected to grow rapidly with a proliferation of gas-electric hybrid vehicles. The safety issues, among other issues such as energy density, will be given even higher priority in transportation applications.

Several solid substances have been tried as solid electrolytes, including: sulfide glasses and sulfide crystalline material. However, lithium ion battery applications generally necessitate that the solvent-free electrolytes be formed into a thin membranes/films with a large area, sufficiently large to produce a low internal resistance, thereby yielding a high current. However, thus far the various inorganic solid electrolytes are so fragile that limited battery uses exist.

Also, currently available solvent-free polymer electrolytes or inorganic solid electrolytes have too low an ionic conductivity, <10⁻⁴ S cm⁻¹ for practical applications. On the other hand, a conventional organic solvent based electrolyte has typically a conductivity of 10⁻² S cm⁻¹. Current gel-type polymers swollen with organic solvents, while having a higher conductivity than solvent free electrolytes, have similar problems to those in liquid electrolytes. Polymers used for solvent free electrolytes include polyethylene oxide (PEO), poly(propylene oxide), poly(ethylene succinate), and others. It is known that amorphous polymers have higher conductivity than crystalline polymers. Various attempts to make amorphous polymers such as random/block copolymerization, branching, and cross-linking have been made with limited success.

### BRIEF SUMMARY OF THE INVENTION

An object of the present invention is to provide a solvent-free electrolyte suitable for use in a lithium ion battery.

Another object of the present invention is to furnish a solvent-free electrolyte that serves as a membrane/film electrolyte in lithium ion batteries.

A further object of the present invention is to supply a pegylated fullerene that functions as a solvent-free or solid electrolyte in lithium ion batteries.

Still another object of the present invention is to disclose various poly(ethylene oxide) derivatized C₆₀ compounds that serve as useful solvent-free battery electrolytes.

Yet a further object of the present invention is to describe pegylated C₆₀ containing membranes/films that serve as solvent-free electrolytes for lithium ion batteries.

Disclosed, for use with a lithium ion battery, is a solvent-free or solid electrolyte having the formula {[(CH₃-(PEO)]ₘ-LINKER)}ₙ-fullerene, with n≧1 to 60, m≧1 to 5, and the LINKER a moiety capable of attaching each of the CH₃-(PEO)-chains to the fullerene. Additionally, the subject invention also includes membranes/films containing {[(CH₃-(PEO)]ₘ-LINKER)}ₙ-fullerene, with n≧1 to 60, m≧1 to 5, and the LINKER a moiety capable of attaching each of the CH₃-(PEO)-chains to the fullerene. More specifically, the fullerene is usually C₆₀. Various suitable LINKER moieties exist and are presented in detail below.

Further objects and aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 shows an exemplary multi-PEOC₆₀ anion and the existence of “n” negative charges that produce the anion.

FIG. 2 shows chemical representations for two specific forms of poly(ethylene oxide), Mono PEOC₆₀ and Di PEOC₆₀, general mixing agents in the subject invention, wherein a general formula is C₆₀{N(CH₂CH₂O)ₙ CH₃}ₘ with “n” running from 1 to about 60 and “m” running from 1 to 2 or greater.

FIG. 3 shows a chemical representation for a general mixing agent in the subject invention, wherein the general formula is C₆₀{CH₂C₆H₄O(CH₂CH₂O)ₙCH₃}ₘ with “n” running from 1 to about 60 and “m” running from 1 to about 8 or greater.

FIG. 4 shows a synthesis scheme for exemplary C₆₀{CH₂C₆H₄O(CH₂CH₂O)ₙCH₃}m (multi-PEO fullerene [PEOₘC₆₀] derivatives with various length sizes and numbers of PEOₘ chains) molecules by atom transfer radical addition (ATRA) reactions.

FIG. 5 shows the azide addition of PEO-azide to fullerene synthesis scheme utilized to produce exemplary C₆₀{(NCH₂CH₂O)ₙCH₃}ₘ molecules, made with numbers of and various lengths of PEO chains.

FIG. 6 shows a proposed reaction mechanism for the synthesis of poly(ethylene oxide) attached fullerenes.

FIG. 7 shows the proton NMR spectrum for multi-PEO fullerenes.

FIGS. 8A and 8B show EPR spectra for organic (8A) and transition metal (8B) radical signals from samples of (PEO₃)ₘC₆₀.

FIGS. 9A and 9B show MALDI-TOF spectra of (PEO₃)ₘC₆₀, (9A) and (PEO₈)ₘC₆₀ (9B).

FIG. 10 shows the UV-VIS spectra of Di (PEO₁₆)C₆₀ in various solvents and thin film.

FIG. 11 shows a first synthesis approach for producing regio-specific pegylation of fullerenes.

FIG. 12 shows a second synthesis approach for producing regio-specific pegylation of fullerenes.

FIG. 13 shows a third synthesis approach for producing regio-specific pegylation of fullerenes.

### DETAILED DESCRIPTION OF THE INVENTION

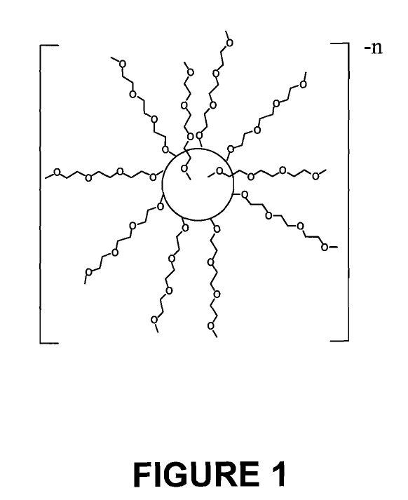

Referring more specifically to the drawings, for illustrative purposes the present invention is embodied in the apparatus generally shown in FIG. 1 through FIG. 13. It will be appreciated that the pegylated fullerene (PEOC₆₀) structures may vary as to configuration without departing from the basic concepts as disclosed herein.

As a group of special spherical π-electron carbon clusters, it has been found that fullerenes possess very unique electronic, magnetic, optical and biomedical attributes including: semiconductivity; magnetic properties; superconductivity; nonlinear optical properties; anti-oxidation properties; anti-cancer properties; and possibly anti-HIV properties. Unfortunately, fullerenes are only sparingly soluble in most common solvents. Chemical functionalization of fullerenes can produce useful and practical applications that exploit the unique properties shown by fullerenes.

Several chemical functionalization procedures are available for modifying fullerenes. Among these procedures, addition and cycloaddition reactions are the most useful synthetic methods to functionalize fullerenes: including the Bingel (cyclopropanation of fullerenes via the reaction with bromomalonates in the presence of base); the Bingel-Hirsch (cyclopropanation of fullerenes with diethyl bromomalonate and base to give dicarbethoxymethanofullerenes); the Prato (addition of azomethine ylides to give N-methylfulleropyrrolidines); and azoalkane cycloaddition reactions.

Among the various functional groups covalently attached to fullerene to render it functional and soluble is polyethylene glycol (PEG) (hydrophilic in basic nature) through what has been termed a “pegylation” reaction. Pegylated fullerenes are hydrophilic polymers having various material science and biologically applications and are very effective surfactants for aiding in mixing non-pegylated fullerenes into membrane/film compositions with host polymers (e.g. Nafion and similar polymers). Pegylated fullerenes can have much higher solubility, miscibility, and processibility characteristics than unmodified fullerenes.

Generally, a pegylated carbon cluster comprises one or more poly(ethylene oxide) (PEO) side chains attached to a carbon cluster by various linking structures. Preferably, the carbon cluster comprises a fullerene family member or equivalent molecule such as a carbon nano-tube, open or closed carbon cage-molecule, and the like, preferably C₆₀. It must be pointed out that fullerenes come in other forms than the common C₆₀ species and that these other fullerenes (C₂₀, C₇₀, C₇₆, C₈₄, C₈₆, and the like) are also within the realm of this disclosure.

In the subject invention, PEG chains are adducted to C₆₀ in several ways, including an atom transfer radical addition reaction and an azide addition reaction. The subject invention has the following advantages over existing synthesis methods: 1) the subject atom transfer radical addition (ATRA) reaction allows for attachment of multiple PEG chains, of various lengths, onto a fullerene (it is stressed that suitable other types of polymers can be functionalized with this procedure) and this reaction is not moisture sensitive; 2) the subject ATRA reaction permits the synthesis of multiple PEG chain-attached fullerenes having various PEG chain lengths with a high yield by adjusting the ratio of fullerene to a PEG benzyl bromide intermediate; 3) regio-specific multi-pegylated fullerenes are produced; 4) the pegylated fullerenes can serve as lithium solid electrolytes in Li-ion batteries; and 5) the various subject pegylated fullerenes have good solubility in general aromatic and polar solvents, are miscible with other polymers, and serve as excellent surfactants by improving the miscibility of other fullerenes with various polymers (e.g. facilitating the production of various useful films and membranes).

Concerning derivatized fullerenes being utilized as a lithium solid electrolyte, fullerenes, in general, are unique in that they have high electron affinities, thus, selectively functionalization (pegylation) of a fullerene surface would provide good hopping sites for Li⁺ion transportations in a solid electrolyte. This mechanism enables elimination of organic solvents. C₆₀ attached by multiple PEO chains has an extremely high surface and volumetric density of CH₂CH₂O units, the Li⁺hopping sites. Furthermore, a branching structure of PEO chains attached to C₆₀ prevents crystallization. Attaching PEO chains to C₆₀ also creates voids in an electrolytic-membrane or similar structure for better Li⁺-ion transportation. The length, number, and regio-specificity of PEO chains attached to C₆₀ can be controlled, as is fully illustrated below. As seen in FIG. 1, derivatized fullerenes can also delocalize electrons on the functional groups. This not only promotes the Li⁺-ion hopping, but also makes fullerenes good counter anions for the Li⁺cation. Thus, fullerene derivatives are good candidates for being “bifunctional electrolytes.” Such a bifunctional electrolyte serves both as part of a Li⁺salt and as a substitute for the replaced organic solvent. In general, C₆₀ is stable against oxidation and forms a stable anion.

The advantages of such fullerene electrolytes would be the following: 1) the delocalization of electrons promotes lithium ion dissociation, increasing the number of free charge carriers, leading to a high ionic conductivity; 2) the immobility of fullerenes as the counter anion makes the transference number close to 1, an ideal number for lithium ion batteries; 3) provided that the geometrical arrangement of hopping sites in pegylated fullerenes are optimized for lithium ion transportation, the lithium ion mobility can be greater than that in liquid electrolytes where the radius of mobile ions is that of solvated Li⁺ion, instead of lithium ion itself (again, this results in a high ionic conductivity); and 4) Li⁺ion hopping sites in pegylated fullerenes eliminate dangerously flammable liquid organic solvents.

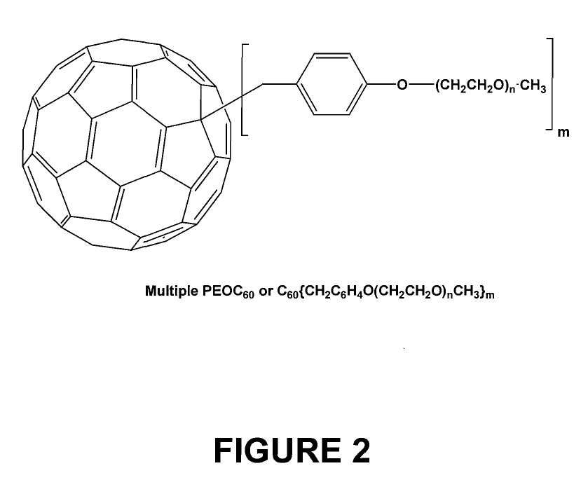

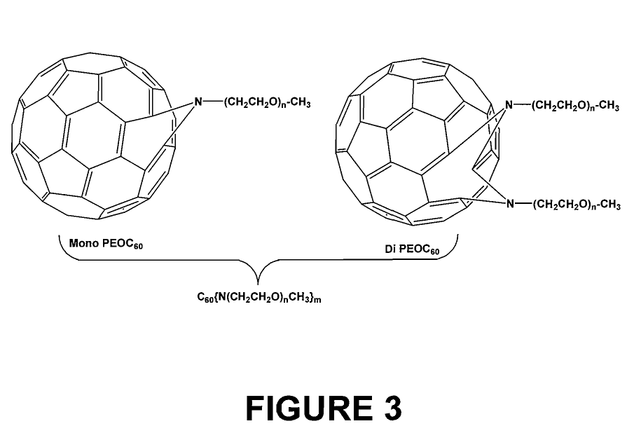

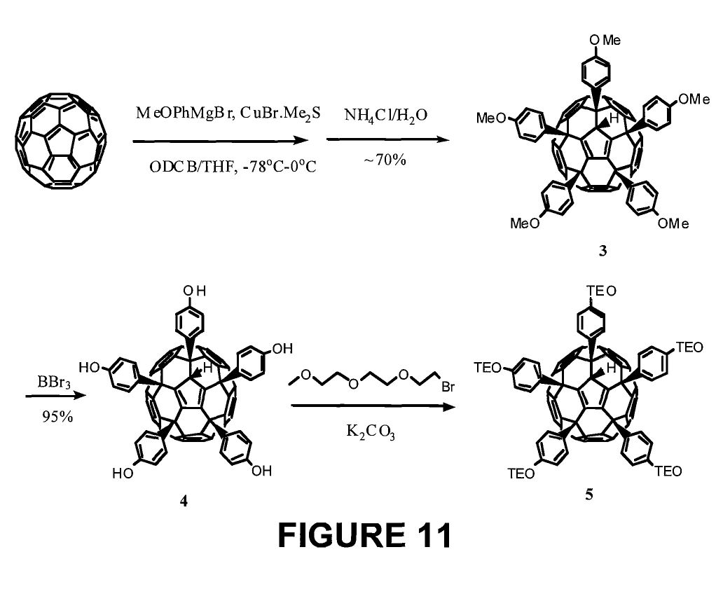

Subject poly(ethylene oxide) attached fullerenes (utilizing C₆₀ as an exemplary member of the fullerene family and not by way of limitation) that may be utilized as lithium solid electrolytes may be expressed as C₆₀{(NCH₂CH₂O)ₙCH₃}ₘ, C₆₀{CH₂C₆H₄O(CH₂CH₂O)ₙCH₃}ₘ, wherein “n” and “m” range from 1 to about 45 and from 1 to about 8 or greater, respectively, and as other regio-specific fullerenes having multiple PEO chains (see below). FIGS. 2, 3, and 11-13 illustrate some non-limiting examples of subject pegylated fullerenes. The actual chemical linkage of the poly(ethylene oxide) moiety to the fullerene may vary as long as the linkage means does not interfere with the proper functioning and structural integrity of the generated solid electrolyte. In general, FIG. 3 illustrates nitrogen facilitated linkages to generate mono and di poly(ethylene oxide) derivatives of fullerene (mono- and di-C₆₀ poly(ethylene oxide) (PEOC₆₀), respectively). FIG. 2 depicts phenyl linkages from multiple poly(ethylene oxide)s to a C₆₀ poly(ethylene oxide) (PEOC₆₀) core. FIGS. 11-13 show regio-specific pegylated C₆₀ structures. Again, it is stressed that fullerenes come in other forms than the common C₆₀ species and that these other fullerenes (C₂₀, C₇₀, C₇₆, C₈₄, C₈₆, and the like) and equivalent poly(ethylene oxide) derivatives are also within the realm of this disclosure, as long as they function as suitable solvent-free or solid electrolytes for lithium ion batteries.

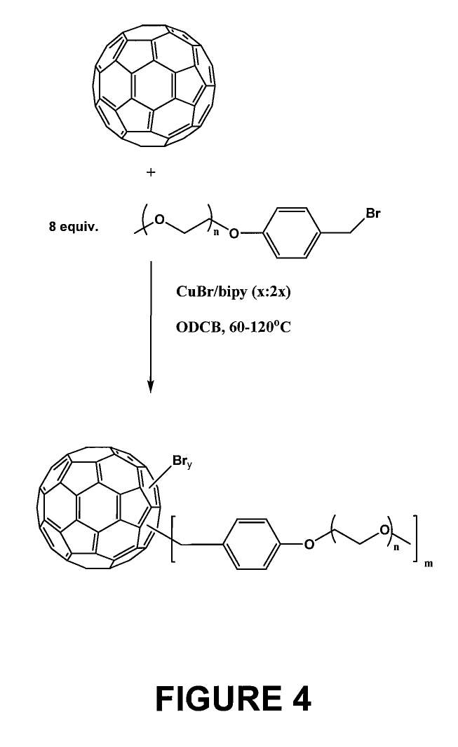

The exemplary C₆₀{CH₂C₆H₄O(CH₂CH₂O)ₙCH₃}ₘ (multi-PEO fullerene [PEOₘC₆₀] derivatives with various length sizes and numbers of PEOₘ chains) molecules were designed and synthesized by atom transfer radical addition (ATRA) reactions (see FIG. 4). It is noted that apparently a limited amount of bromine is incorporated into the final fullerene compounds (the bromine is not indicated in the FIG. 2 structure since, apparently, it is the PEOₘ chains that produce the pegylated fullerene's useful properties and not the small amount of bromine).

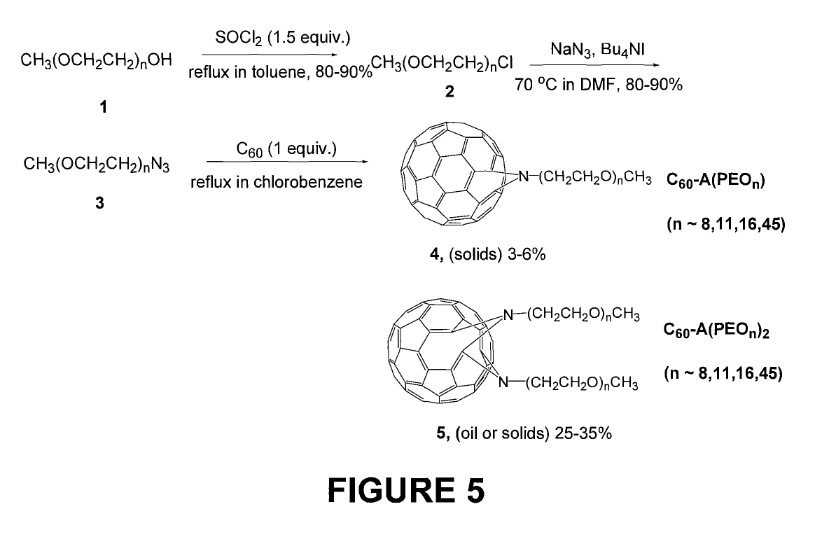

The exemplary C₆₀{(NCH₂CH₂O)ₙCH₃}ₘ molecules, made with various length of PEO chain, were synthesized by azide addition of PEO-azide to fullerene (as seen in FIG. 5). The synthesis followed the procedure from literature. (Hawker, C. J., Saville, P. M., and White, J. W., J. Org. Chem. 1994, 59, 3503 and Huang, X. D., Goh, S. H., and Lee, S. Y., Macromol. Chem. Phys. 2000, 201, 2660) However, unlike those fullerene azide addition reactions, in which mono-azide addition products are always the major products, here we found bis-azide addition products were the major products in all the reactions (see Table 2). Only trace amount of mono-azide addition products were detected.

If desired, pegylated fullerenes may be mixed with other host polymers and used to produce thin films, if desired. The pegylated fullerenes are excellent surfactants. Examples of host polymers that easily mix with pegylated fullerenes include NAFION (DuPont), poly(arylene ether sulfone), poly(phosphazines), polyethers, poly(vinyl pyrrolidone), poly(phenylene ether), and other equivalent materials. Such mixtures have been used to make various useful fuel cell membranes.

Pegylated fullerene species that contain regio-specific pegylation (a more specific surface location for the attachment of PEO chains than non-regio-specific pegylation yields) have been synthesized in several novel synthesis schemes (detailed below in Example 3 of the Experimental Examples section of this disclosure).

Thus, generally, the subject solvent-free or solid electrolyte comprises derivative fullerenes having structures represented by formula 1:
{[CH₃-(PEO)]ₘ-LINKER}ₙ-fullerene (1 )
where n=1 to 60 or more and usually n>1 and up to 60 or more, m≧1 to 5, and the “LINKER” group comprises a moiety capable of attaching the CH₃-(PEO)-chain or chains to the fullerene. For use as an electrolyte, the LINKER attaches the CH₃-(PEO)-chain or chains in such a manner that it does not interfere with the solvent-free electrolytic properties of the product. Various suitable “LINKER” structures are specifically disclosed above and below as the moieties that link the CH₃-(PEO)-chains in various suitable connections to the fullerenes. For the regio-specific derivatives, the “LINKER” group comprises a moiety capable of attaching the CH₃-(PEO)-chains to the fullerene in a regio-specific attachment in which the CH₃-(PEO)-chains are focused into a region on the fullerene.

More specifically, the subject solvent-free or solid electrolyte comprises derivative C₆₀s having structures represented by formula 2:
{[(CH₃-(PEO)]ₘ-LINKER}ₙ-C₆₀ (2)
where n=1 to 60 and usually n>1 and up to 60, m≧1 to 5, and the “LINKER” group comprises a moiety capable of attaching the CH₃-(PEO)-chain or chains to the C₆₀. Again, for use as an electrolyte, the LINKER attaches the CH₃-(PEO)-chain or chains in such a manner that it does not interfere with the solvent-free electrolytic properties of the product. Once again, various suitable “LINKER” structures are specifically disclosed above and below as the moieties that link the CH₃-(PEO)-chains in various suitable connections to C₆₀. Again, for the regio-specific derivatives, the “LINKER” group comprises a moiety capable of attaching the CH₃-(PEO)-chains to the C₆₀ in a regio-specific attachment in which the CH₃-(PEO)-chains are focused into a region on the C₆₀.

### EXPERIMENTAL EXAMPLES

### Example 1

### Preparation of Poly(Ethylene Oxide) Attached Fullerenes by the ATRA Method

Generally, poly(ethylene oxide) monomethyl ethers (for example, where n˜3, 8, 12, 17, and 45) were functionalized with benzyl bromide in three steps as shown immediately below in Scheme 1:

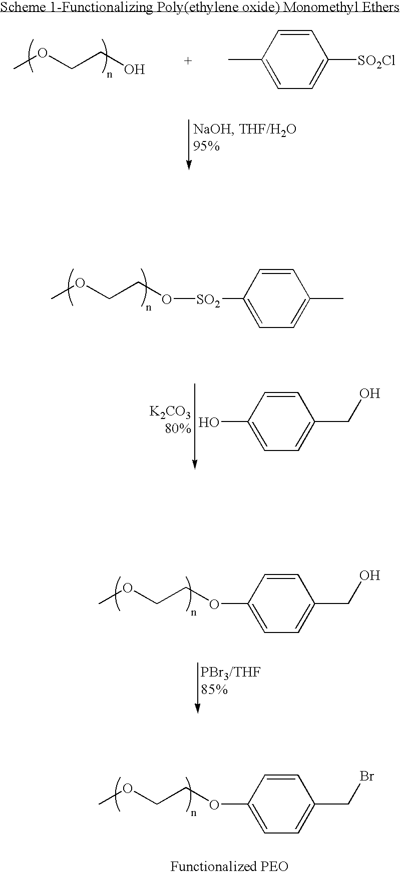

As seen in FIG. 4, in the ATRA step, the fullerene was first dissolved in o-dichlorobenzene (ODCB) in a pressure vessel, then 8 equivalents of PEO-benzylbromide (one equivalent yields a mono-PEO final product and the like) and 2,2′-bipyridine were added and the solution was degassed . After the desired equivalents (8 equivalents in FIG. 4) of CuBr was added, the vessel was sealed and heated until a green precipitate formed. Air was bubbled through the reaction mixture to precipitate un-reacted copper (I) complex. Upon filtration, the solution was concentrated and precipitated into ether. The product, with “n” final PEO chains and “y” bromines, was collected by filtration as a brown oil or solid (final yield was ˜90%).

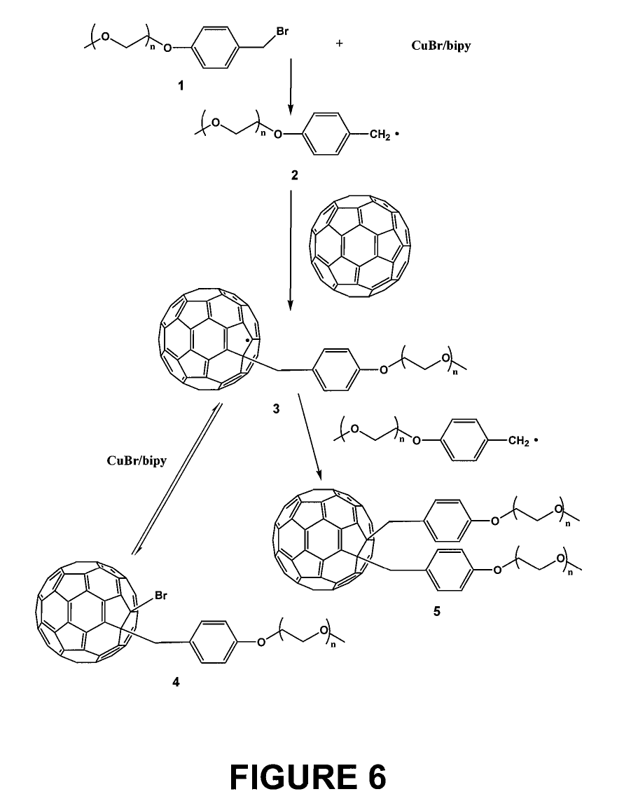

The proposed mechanism for the reaction is presented in FIG. 6.

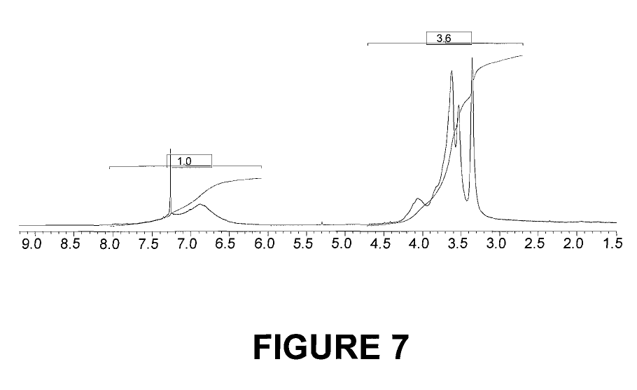

¹H-NMR spectra of multi-PEO fullerenes in CDCl₃ (FIG. 7) give very broad signals, no signal of fullerene carbon was observed from ¹³C-NMR spectra. Both indicates the existence of radicals and (or) random additions of PEG chains to fullerene molecules.

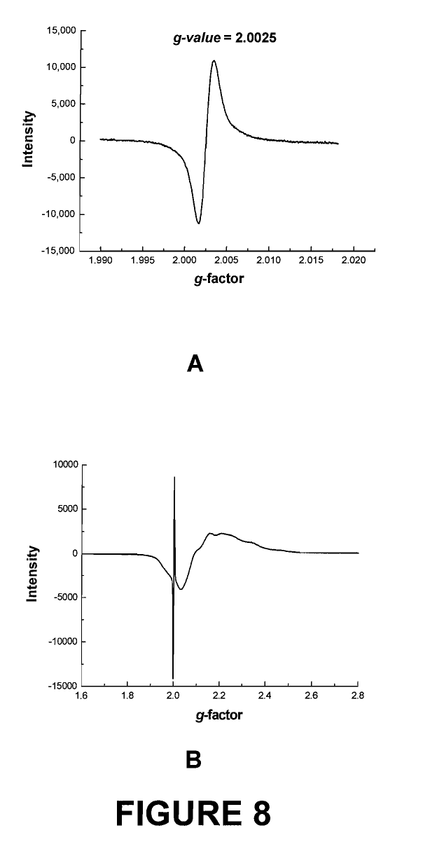

As seen in FIGS. 8A and 8B, two types of radicals were discovered from EPR study of (PEO₃)ₘC₆₀ solid and solution samples. The results indicate that some (PEO₃)ₘC₆₀ molecules (<1% from calculation) have radicals and small amount of Cu(II) residue still left in the sample (both organic (FIG. 8A) and transitional metal (FIG. 8B) radical signals).

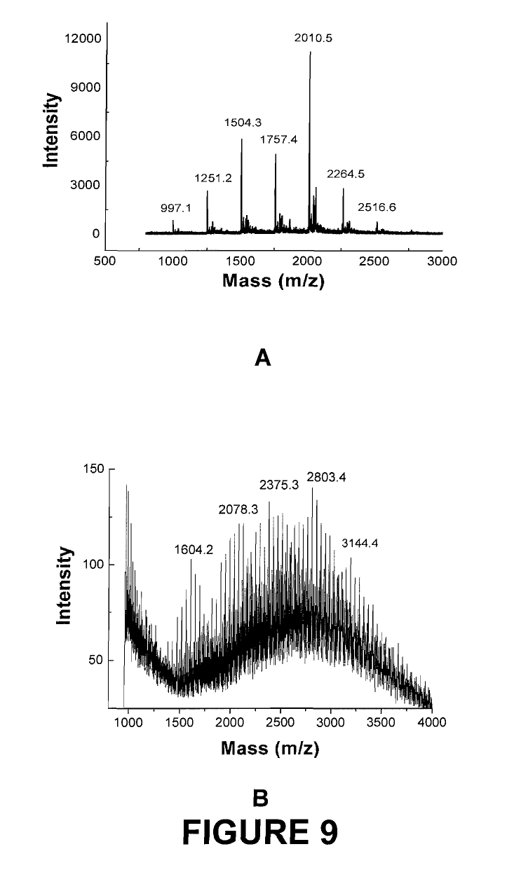

Elemental analysis of (PEO₃)ₘC₆₀ (see Table 1) confirmed the existence of Br and Cu(II) residues. Calculation based on the ratio of H gives 5 PEO₃ chains attached to each fullerene molecule by average, which is confirmed by MALDI spectrum of (PEO₃)ₘC₆₀ (see FIG. 9 with (PEO₃)ₘC₆₀ (FIG. 9A) and (PEO₈)ₘC₆₀ (FIG. 9B)). When longer PEO chains were used in the reaction, fewer numbers of PEOs were reacted to each fullerene molecule probably due to the steric hindrance. To further remove the Cu(II) residue, (PEO₃)ₘC₆₀ was dissolved in CHCl₃ and bubbled with H₂S for 4 hours. After this process, the Cu(II) EPR signal disappeared and the fullerene radical signal had no change.

One can see from the MALDI data of (PEO₃)ₘC₆₀ (FIG. 9A) and (PEO₈)ₘC₆₀ (FIG. 9B) that m is ranged from 1 to 8, with an average number about 4 to 5. From the elemental analysis of (PEO₃)ₘC₆₀, there is 1.6% bromine, which equals about 0.4 bromine (or y˜0.4) per PEO fullerene, on average. The existence of bromine can be explained by the reactions mechanism (FIG. 6), when a PEO-benzyl radical (compound 2) reacted with a fullerene double bond, a fullerene radical (compound 3) formed. This fullerene radical reacted with either another PEO-benzyl radical to give compound 5 or reversible abstracted bromine from the copper complex (or perhaps compound 1) to give compound 4. Again, any possible bromine is not shown in FIG. 2 since the bromine appears to very limited.

More specifically, the C₆₀(PEOₘ}ₙ with various PEO lengths were synthesized in 4 steps with an atom transfer radical addition reaction (ATRA) as the final step to attach multiple PEO chains to the fullerene molecules, as noted above. In a typical ATRA step, C₆₀ (720 mg, 1 mmol), poly(ethylene oxide) benzyl bromide (8 mmol) and bipyridine (1.56 g, 10 mmol) were dissolved in 100 ml ODCB in a 150 ml pressure vessel. The solution was degassed for 10 minutes and CuBr (0.789 g, 8 mmol) was quickly added. The vessel was sealed and heated at 110° C. for 2 days until the green precipitation came out. H₂S was bubbled through the solution to completely precipitate Cu residue, then the solution was filtrated and ODCB was removed under vacuum. The black residue was washed with Et₂O (200 ml) 3 times to remove un-reacted PEO monomers.

### Example 2

### Preparation of Poly(Ethylene Oxide) Attached Fullerenes by the Azide Addition Method

Generally, the exemplary azide addition fullerenes or C₆₀{(NCH₂CH₂O)ₙCH₃}ₘ molecules, made with various length of PEO chains, were synthesized by azide addition of PEO-azide to fullerene (as seen in FIG. 5). As indicated above, the synthesis followed the procedure from literature. (Hawker, C. J., Saville, P. M., and White, J. W., J. Org. Chem. 1994, 59, 3503 and Huang, X. D., Goh, S. H., and Lee, S. Y., Macromol. Chem. Phys. 2000, 201, 2660) Once again, unlike those fullerene azide addition reactions, in which mono-azide addition products are always the major products, here we found bis-azide addition products (compounds 5 in FIG. 5 or the Di PEOC₆₀ with n=8, 11, 16, and 45 seen FIG. 3) were the major products in all the reactions. Only trace amount of mono-azide addition products (compounds 4 in FIG. 5 or the Mono

PEOC₆₀ with n=8, 11, 16, and 45 seen FIG. 3) were detected. The structure of compounds 4 and 5 were confirmed by ¹H-NMR, ¹³C-NMR and elemental analysis. DSC and TGA studies showed that these materials are thermally stable up to 220° C.

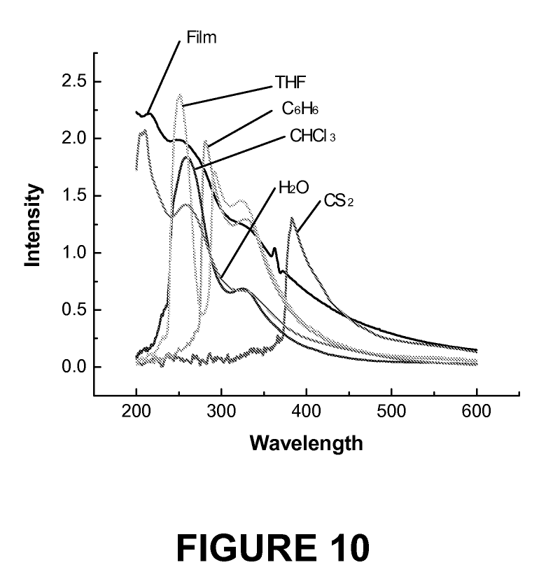

The bis-azide addition fullerenes are very soluble in common organic solvents such as toluene, methylene chloride, chloroform, THF and methanol. Di (PEO₁₆)C₆₀ and Di (PEO₄₅)C₆₀ are soluble in water. UV-VIS spectra of Di (PEO₁₆)C₆₀ in various solvents and thin film are shown in FIG. 10. The large shifts of UV absorption in different solvents strongly indicate aggregation of these molecules.

### Example 3

### Regio-Specific Pegylation of Fullerenes

Three different synthesis schemes are presented in FIGS. 11-13. The disclosed species are for exemplary purposes only and are not intended to limit the equivalents of the compounds utilized. FIG. 11 relates a synthesis scheme for making a penta-triethylene oxide derivative of C₆₀ in which each triethylene oxide group is linked to the C₆₀ by a phenyl moiety yielding [(PEO)-C₆H₄]ₙ-C₆₀ species, wherein “n” runs from 1 to 5 or greater. Initially, C₆₀ was reacted with MeOPhMgBr, CuBr, and Me₂S in ODCB/THF at −78° C. −0° C. This was followed with the addition of NH₄Cl in water which gave compound 3, in FIG. 11, at about a 70% yield. BBr₃ was added to compound 3 to yield compound 4, in FIG. 11, at about a 95% yield. Polyethylene glycol (in this exemplary case triethylene glycol, but other chain lengths are considered to be within the realm of this disclosure) was added to compound 4 in the presence of K₂CO₃ to produce the regio-specific penta-TEO (penta-triethylene oxide) product, compound 5, in FIG. 11.

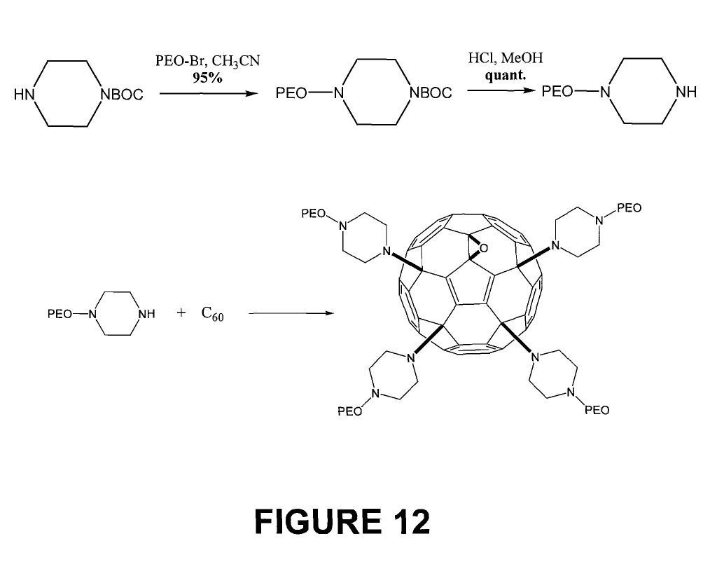

FIG. 12 presents a synthesis scheme for producing a tetra-PEO derivative of C₆₀ in which each PEO group is linked to the C₆₀ by a heterocyclic moiety yielding [(PEO)-N₂C₄H₈]ₙ-C₆₀ species wherein “n” runs between 1 and four and greater. Clearly, the length of the PEO chain is variable in this example. BOC-piperazine (C₄H₉N₂BOC) was reacted with PEO-Br and CH₃CN to produce, in approximately 95% yield, pegylated BOC-piperazine. This intermediate was then reacted with HCl in MeOH to quantitatively generate mono-pegylated piperazine. Mono-pegylated piperazine was then reacted with C₆₀ to produce the tetra-PEO C₆₀ derivative shown as the end product in FIG. 12.

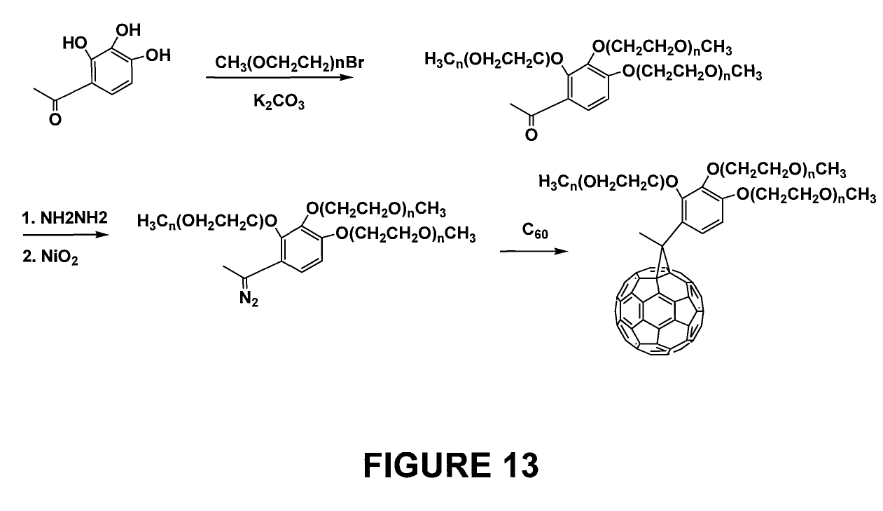

FIG. 13 outlines a synthesis scheme for creating an additional type of multi-PEO C₆₀ derivative having the general formula of {[(PEO)ₙ-phenyl]ₓ-spacer}ₘ-C₆₀ , wherein n=1 to 5, x=1 to 2, m≧1 and the “spacer” is a carbon containing structure that may have an additional “(PEO)ₙ-phenyl-” group attached to it when x=2. Starting compound C₈H₈O₄ (an aldehyde containing a trihydroxyphenyl group or other equivalent structures, but it may be a ketone having a second multi-hydroxyphenyl moiety or other equivalent structures) was reacted with CH₃(OCH₂CH₂)ₙBr (or generally CH₃(PEO)Br with variable length PEOs) and K₂CO₃ to produce the tri-pegylated aromatic compound shown in FIG. 12. This tri-pegylated aromatic compound was then reacted with NH₂NH₂ and NiO₂ to create a fullerene-reactive “=N₂” containing tri-pegylated aromatic compound which was then reacted with C₆₀ to generate the tri-pegylated C₆₀ end product shown in FIG. 13. Plainly, the three attached PEOs are not randomly spread over the surface of the C₆₀, but are concentrated in a regio-specific location on the C₆₀.

### Example 4

### Thin Film Preparation

1. Appropriate amounts of PEOₘC₆₀ (with various linkages between a PEO and a C₆₀) were weighed and added to ˜5 g of Chlorobenzene.

2. If needed, a desired additional polymer (Nafion, etc.) is added to ˜5 g of chlorobenzene in a separate container. This may or may not be desirable, depending on the exact application encountered.

3. These mixtures were sonicated (˜10 mins).

4. They were then stirred in an 85° C. oil bath for 1˜2 hours.

5. After confirming complete dissolution, they were mixed together, if desired, and stirred for about 1 hour at 85° C. in an oil bath.

6. The resultant homogeneous solution was poured into a TEFLON dish and dried (thereby removing the solvent to produce the “solvent-free” or solid electrolytic membrane/film) in a 120° C. oven for 2˜3 hours to get a composite thin membrane/film.

Additionally, it is noted, that since a low Tg naturally goes hand-in-hand with a pegylated C₆₀, an electrode membrane can be formed by spin-casting of the pegylated C₆₀ film-mixture onto lithium containing electrodes. The PEO chain length and the number of PEO chains attached to C₆₀ can be optimized to give the best desired performance situation (the operation temperature, the rate performance, the cycling, the self-discharge, and the like) for any specific application, such as lithium battery electrolytes.

Although the description above contains many details, these should not be construed as limiting the scope of the invention, but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a compound, structure, or composition to address each and every problem sought to be solved by the present invention, for it to be encompassed by the present claims. Furthermore, no compound, structure, or composition in the present disclosure is intended to be dedicated to the public regardless of whether it is explicitly recited in the claims.

TABLE 1
Elemental Analysis Result for (PEO₃)ₘC₆₀
Produced by the ATRA Method

| Sample ID | % C | % H | % Br | % Cu |
|---|---|---|---|---|
| C60TEGN | 72.82 | 5.64 | 1.57 | 0.79 |

TABLE 2
Elemental Analysis of Pegylated C₆₀s Produced
by the Azide Addition Method

| Formula | | % C | % H | % N |
|---|---|---|---|---|
| C₆₀-A(PEO₄₅)₂ | Calculated | 64.34 | 6.71 | 0.52 |
| | (Mono-PEO) | | | |
| | Calculated | 61.40 | 7.75 | 0.60 |
| | (Bis-PEO) | | | |
| | Found | 61.20 | 7.45 | 0.57 |
| C₆₀-A(PEO₁₂)₂ | Calculated | 74.4 | 6.11 | 0.86 |
| | (Mono-PEO) | | | |
| | Calculated | 66.8 | 6.65 | 1.11 |
| | (Bis-PEO) | | | |
| | Found | 66.35 | 6.84 | 1.10 |

What is claimed is:

1. A solvent-free electrolyte comprising one or more pegylated fullerenes.

2. A solvent-free electrolyte according to claim 1, where said fullerene is C₆₀.

3. A solvent-free electrolyte according to claim 1, wherein said pegylated fullerene is selected from a group consisting of C₆₀{N(CH₂CH₂O)ₙCH₃}ₘ wherein n =1 to 60 and m=1 and C₆₀{CH₂C₆H₄O(CH₂CH₂O)ₙCH₃}ₘ wherein n=1 to 60 and m=1.

4. A solvent-free electrolyte comprising one or more multi-pegylated fullerenes.

5. A solvent-free electrolyte according to claim 4, wherein said multi-pegylated fullerene is selected from a group consisting of C₆₀{N(CH₂CH₂O)ₙ CH₃}ₘ wherein n=1 to 60 and m>1 and C₆₀{CH₂C₆H₄O(CH₂CH₂O)ₙ CH₃}ₘ wherein n=1 to 60 and m>1.

6. A solvent-free electrolyte for use in a lithium ion battery comprising one or more pegylated fullerenes.

7. A solvent-free electrolyte for use in a lithium ion battery according to claim 6, wherein said pegylated fullerene is selected from a group consisting of C₆₀{N(CH₂CH₂O)ₙ CH₃}ₘ wherein n=1 to 60 and m=1 and C₆₀{CH₂C₆H₄O(CH₂CH₂O)ₙCH₃}ₘ wherein n=1 to 60 and m=1.

8. A solvent-free electrolyte for use in a lithium ion battery comprising one or more multi-pegylated fullerenes.

9. A solvent-free electrolyte according to claim 8, wherein said multi-pegylated fullerene is selected from a group consisting of C₆₀{N(CH₂CH₂O)ₙ CH₃}ₘ wherein n=1 to 60 and m>1 and C₆₀{CH₂C₆H₄O(CH₂CH₂O)ₙ CH₃}ₘ wherein n=1 to 60 and m>1.

10. A solvent-free electrolyte according to claim 8, wherein said multi-pegylated fullerene is selected from a group consisting of C₆₀{N(CH₂CH₂O)ₙ CH₃}ₘ wherein n=1 to 60 and m>1, C₆₀{CH₂C₆H₄O(CH₂CH₂O)ₙ CH₃}ₘ wherein n=1 to 60 and m>1, [(PEO)-C₆H₄]ₙ-C₆₀ wherein n>1, [(PEO)-N₂C₄H₈]ₙ-C₆₀ wherein n>1, and {[(PEO)ₙ-phenyl]ₓ-spacer}ₘ-C₆₀, wherein n>1, x=1 to 2, m≧1 and said “spacer” is a carbon containing structure.

11. A solvent-free electrolyte comprising {[CH₃-(PEO)]ₘ-LINKER}ₙ-fullerene, wherein n≧1, m≧1 to 5, and said LINKER comprises a moiety capable of attaching each said CH₃-(PEO)- to said fullerene.

12. A solvent-free electrolyte comprising {[(CH₃-(PEO)]ₘ-LINKER}ₙ-C₆₀, wherein n≧1 to 60, m≧1 to 5, and said LINKER comprises a moiety capable of attaching each said CH₃-(PEO)- to said C₆₀.

13. A solvent-free electrolyte comprising {[CH₃-(PEO)]ₘ-LINKER}ₙ-fullerene, wherein n>1, m≧1 to 5, and said LINKER comprises a moiety capable of attaching each said CH₃-(PEO)- to said fullerene.

14. A solvent-free electrolyte comprising {[(CH₃-(PEO)]ₘ-LINKER}ₙ-C₆₀, wherein n>1 to 60, m≧1 to 5, and said LINKER comprises a moiety capable of attaching said CH₃-(PEO)- to said C₆₀.

15. For use with a lithium ion battery, a solvent-free electrolyte film containing {[CH₃-(PEO)]ₘ-LINKER}ₙ-fullerene, wherein n>1, m≧1 to 5, and said LINKER comprises a moiety capable of attaching each said CH₃-(PEO)- to said fullerene.

16. For use with a lithium ion battery, a solvent-free electrolyte film containing {[(CH₃-(PEO)]ₘ-LINKER}ₙ-C₆₀, wherein n>1 to 60, m≧1 to 5, and said LINKER comprises a moiety capable of attaching each said CH₃-(PEO)- to said C₆₀.

17. A regio-specifically pegylated fullerene compound comprising {[CH₃-(PEO)]ₘ-LINKER}ₙ-fullerene, wherein n≧1, m≧1 to 5, and said LINKER group comprises a moiety capable of attaching each said CH₃-(PEO)- to said fullerene in a regio-specific attachment on said fullerene.

18. A regio-specifically pegylated C₆₀ compound comprising {[CH₃-(PEO)]ₘ-LINKER}ₙ-C₆₀, wherein n≧1 to 60, m≧1 to 5, and said LINKER group comprises a moiety capable of attaching each said CH₃-(PEO)- to said C₆₀ in a regio-specific attachment on said C₆₀.

19. A regio-specifically pegylated C₆₀ compound selected from a group consisting of [(PEO)-C₆H₄]ₙ-C₆₀, wherein “n” runs from 1 to 5, [(PEO)-N₂C₄H₈]ₙ-C₆₀, wherein “n” runs between 1 and 4, and {[(PEO)ₙ-phenyl]ₓ-spacer}ₘ-C₆₀, wherein n=1 to 5, x=1, m≧1, and said “spacer” is a carbon containing structure.

20. A regio-specifically pegylated C₆₀ compound selected from a group consisting of [(PEO)-C₆H₄]ₙ-C₆₀ , wherein “n” runs from 1 to 5, [(PEO)-N₂C₄H₈]ₙ-C₆₀, wherein “n” runs between 1 and 4, and {[(PEO)ₙ-phenyl]ₓ-spacer}ₘ-C₆₀, wherein n=1 to 5, x=1 to 2, m≧1, and said “spacer” is a carbon containing structure.
